(19) United States
(12) Patent Application Publication
(10) Pub. No.: US 2013/0238237 A1
(43) Pub. Date: Sep. 12, 2013

(54) MULTIPLE DATA SOURCES PEDESTRIAN NAVIGATION SYSTEM

(71) Applicants: Ari Abramson Liani, Binyamina (IL); Ilan Efrat, Haifa (IL); Ilya Leizerson, Haifa (IL)

(72) Inventors: Ari Abramson Liani, Binyamina (IL); Ilan Efrat, Haifa (IL); Ilya Leizerson, Haifa (IL)

(21) Appl. No.: 13/878,756

(22) PCT Filed: Oct. 9, 2011
(86) PCT No.: PCT/IB2011/054441

§ 371 Date: Apr. 11, 2013

(30) Foreign Application Priority Data
Oct. 13, 2010 (IL) 208684

(51) Int. Cl. G01C 21/12

(52) U.S. Cl. CPC G01C 21/12
USPC 701/445; 701/500; 701/472; 701/505

(57) ABSTRACT

A method of pedestrian navigation, based on an external positioning system and a Dead Reckoning (DR) system is provided herein. The method may employ the following steps: obtaining external positioning readings from an external positioning source and DR position readings from a pedestrian-carried platform; estimating an external positioning error, based at least partially on the external positioning and the DR position readings; and applying an estimation function to the external position readings, the DR position readings, and the external positioning errors, to yield a corrected estimated position.

### BACKGROUND

1. Technical Field

The present invention relates to pedestrian navigating systems and more particularly, to navigating systems employing more than one data source.

2. Discussion of the Related Art

Two main navigation techniques form some of the related art for the present application. One navigation technique is the “Global Positioning System” or “GPS” being a U.S. space-based global navigation satellite system. In order to provide positioning, navigation, and timing services to worldwide users on a continuous basis, GPS requires an unobstructed view of four or more GPS satellites. GPS satellites broadcast signals from space that GPS receivers use to provide three-dimensional location (latitude, longitude, and altitude), velocity, and precise time. GPS has become a widely used aid to navigation worldwide, and a useful tool for map-making, land surveying, commerce, scientific uses, tracking and surveillance.

Another navigation technique is “Dead reckoning” or “DR” being a process of estimating one's current position based upon a previously determined position, or fix, and advancing that position based upon known or estimated speeds over elapsed time, and course. While traditional methods of dead reckoning are no longer considered primary means of navigation, modern inertial navigation systems, which also depend upon dead reckoning, are very widely used. A disadvantage of dead reckoning is that since new positions are calculated solely from previous positions, the errors of the process are cumulative, so the error in the position fix grows with time.

Two known drawbacks of GPS systems are that they become unreliable in obstructed terrain such as urban canyons and become inoperative whenever the satellite coverage is below a specified threshold. GPS unreliability in obstructed terrain is caused by multipath of GPS satellites signals. This unreliability becomes even worse since standard GPS receivers are usually unaware of multipath conditions and the positioning systems tend to base their positioning on the wrong assumption that their position estimate is still accurate.

### BRIEF SUMMARY

One aspect of the invention provides a method of pedestrian navigation, based on an external positioning system and a Dead Reckoning (DR) system is provided. The method may employ the following steps: obtaining external positioning readings and DR position readings from a pedestrian-carried platform; estimating a GPS error, based at least partially on the GPS and the DR position readings; and applying an estimation function to the GPS position readings, the DR position readings, and the GPS errors, to yield a corrected estimated position.

Another aspect of the invention provides a method that further includes recording a sequence of bodily movements and comparing the recorded sequence to a predefined sequence. The compared sequence is then analyzed to yield calibration data associated with magnetic characteristics of the bodily environment, useable for the DR system. Alternatively, the compared sequence is then analyzed to yield alignment/orientation data associated with orientation or alignment of the DR system on the body, useable for determining direction of advancement of the pedestrian.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating a system according to some embodiments of the invention;

FIG. 2 is a high level flowchart diagram illustrating an aspect relating to a method according to some embodiments of the invention;

FIG. 3 is a high level schematic block diagram illustrating an aspect of a system according to some embodiments of the invention;

FIG. 4 is a high level flowchart diagram illustrating an aspect relating to a method according to some embodiments of the invention;

FIGS. 5A and 5B are a schematic block diagram illustrating an aspect according to some embodiments of the invention;

FIG. 6 is a high level schematic block diagram illustrating an aspect of a system according to some embodiments of the invention; and

FIG. 7 is a high level flowchart diagram illustrating an aspect relating to a method according to some embodiments of the invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

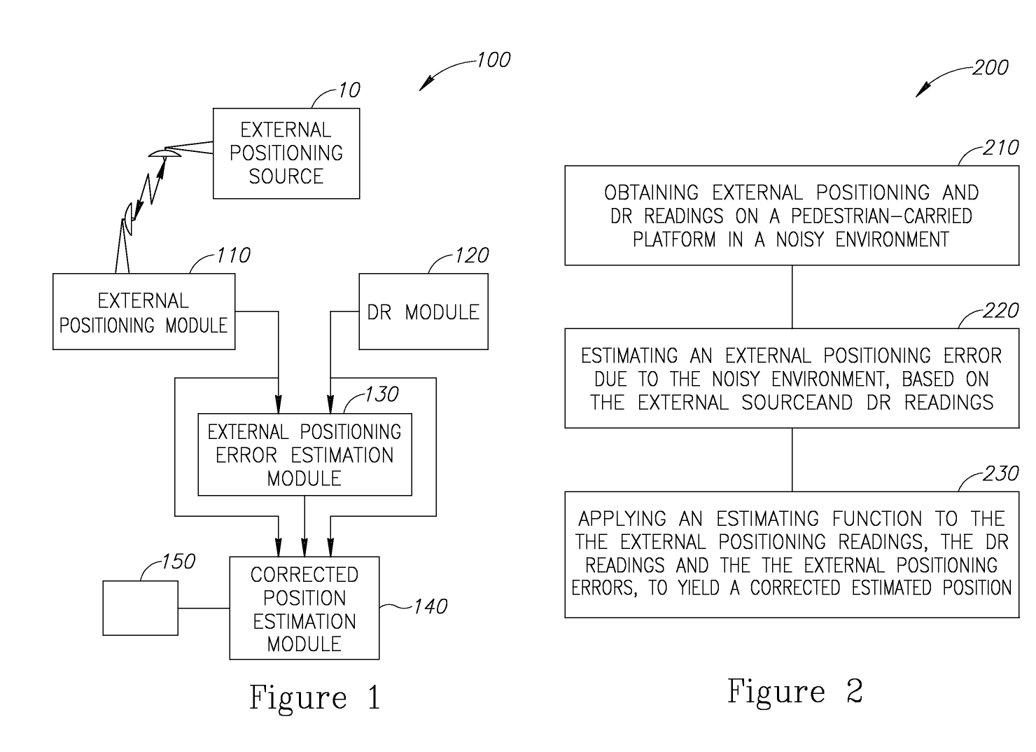

FIG. 1 is a high level schematic block diagram illustrating a system according to some embodiments of the invention. System 100 may include an external positioning module 110; a Dead Reckoning (DR) system 120; an external positioning error estimation module 130; and a corrected position estimation module 140.

In operation, external positioning error estimation module 130 is configured to obtain external positioning and DR position readings from external positioning system 110 and DR system 120 located on a pedestrian-carried platform, wherein the external positioning readings are obtained from external positioning source 10. External positioning module 110 and DR system 120 constantly provide position readings. External positioning error estimation module 130 then estimates an external positioning error, based at least partially on the external positioning and the DR position readings. This is achieved advantageously, by the nature of the DR reading that is continuous and smooth (and so is the DR error).

Then, the estimated external positioning error is inputted into corrected position estimation module 140, where an estimation function is applied to the external positioning readings, the DR position readings, and the external positioning errors, to yield a corrected estimated position. The estimation function can be any existing estimation function such as Kalman filter and the like.

Given the different nature of the external positioning errors (such as GPS errors) and the Dead Reckoning errors, it would be advantageous that the estimation function estimates the external positioning error for a given external positioning reading and a respective dead reckoning reading. This is due to the fact that position errors obtained from the dead reckoning is smoother than that of the external positioning readings. The estimation function is configured to yield a validated value of the current position such that the estimated position error is minimized.

FIG. 2 is a high level flowchart diagram illustrating an aspect relating to a method 200 according to some embodiments of the invention. Method 200 is not necessarily tied to the architecture of the aforementioned system 100 and may include the following steps: obtaining external positioning and DR position readings from a pedestrian-carried platform 210; estimating a external positioning error, based at least partially on the external positioning and the DR position readings 220; and applying an estimation function to the external positioning position readings, the DR position readings, and the external positioning errors, to yield a corrected estimated position 230.

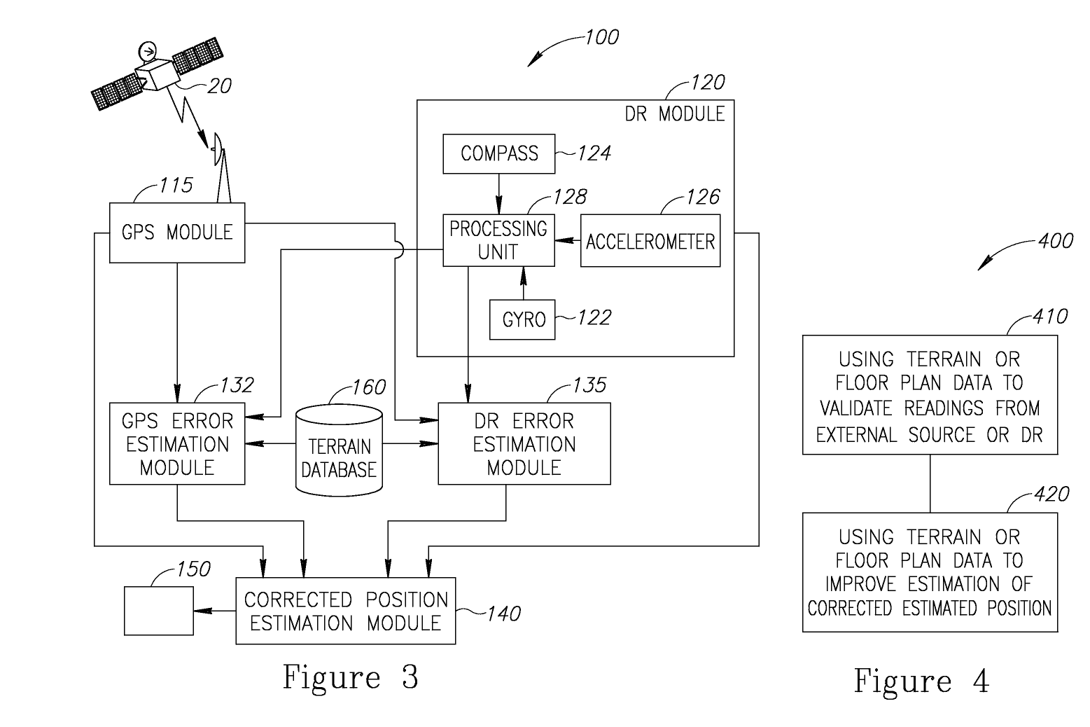

FIG. 3 is a high level schematic block diagram illustrating further aspects of a system according to some embodiments of the invention. For illustrative purposes only, the external positioning system shown is a GPS. It is understood however, that embodiments of the invention may include any external positioning system instead of the GPS.

System 100 may further include, in addition to a GPS module 115 in communication with at least one satellite 20 and GPS error estimation module 132, a terrain/floor plan database 160 and a DR error estimation module 135. In operation, GPS error estimation module 132 and DR error estimation module 135 are configured to derive pedestrian-eligible positions from terrain/floor plan database 160 and estimate GPS errors or DR errors respectively, based on the pedestrian-eligible positions. Then, the estimation function is further applied by corrected position estimated module 140 to the estimated GPS errors or the estimated DR errors respectively, to yield an improved corrected estimated position 150.

Consistent with one embodiment of the invention, the estimation function may be further applied to the pedestrian-eligible positions, directly, or in addition to the aforementioned GPS and DR estimated errors, by corrected position estimated module 140, to yield an improved corrected estimated position 150.

Consistent with one embodiment of the invention, DR error estimation module 135 is further configured to use inertial data derived from gyro 122 and accelerometer 126 outputs and other invariants such as inclination and declination angles in DR system 120 to improve compass 124 readings and to detect compass errors due to magnetic disturbances, resulting in DR errors. Then, estimation function is further applied to the detected DR errors, by corrected position estimated module 140 to yield an improved corrected estimated position 150.

FIG. 4 is a high level flowchart diagram illustrating further aspects relating to a method according to some embodiments of the invention. Method 400 may include: (optionally) using terrain or floor plan data to validate readings from external positioning system or DR 410 and (optionally) using terrain or floor plan data to improve estimation of corrected estimated position 420.

Consistent with one embodiment of the invention, the method may be implemented by deriving pedestrian-eligible positions from a terrain/floor plan database and estimating GPS error or DR error based on the pedestrian-eligible positions, wherein the estimation function is further applied to the estimated GPS error or the estimated DR error to yield an improved corrected estimated position.

Consistent with one embodiment of the invention, the method may be implemented by deriving pedestrian-eligible positions from a terrain/floor plan database, wherein the estimation function is further applied to the pedestrian-eligible positions to yield an improved corrected estimated position.

Consistent with one embodiment of the invention, the method may be implemented with a processing 128 using inertial data such as from gyro 122 and from accelerometer 126 outputs and other invariants such as inclination and declination angles, to improve compass 124 reading and to detect compass errors due to magnetic disturbances, resulting in DR errors, wherein the estimation function is further applied to the detected DR errors, to yield an improved corrected estimated position.

According to another aspect of the present invention, a system and a method of providing calibration for DR systems is further provided. Specifically, there is a need, in DR systems, to determine, at any given time, the correct direction of advancement. Orientation determination is usually achieved by first determining the direction of the magnetic flux and gravitation force of the earth relative to the DR module box. These methods are considered vulnerable in the presence of ‘mounted” iron interferences being interferences due to relatively large amounts of iron being in close proximity to the DR system.

According to some embodiments of the present invention, the system provides a method for ad hoc calibration that enables a determination of the advancement direction and non-progressive orientation at any given time. The calibration process comprises a specified sequence of movements that a human user needs to perform, while wearing the aforementioned system. A non-limiting exemplary specified sequence of movements is bending the torso forward in various orientations. By performing the specified sequence of movements the system is able to compensate for the magnetic interferences mounted on the user, and the actual direction of advancement or at minimum the forward facing direction of the human user may be deduced.

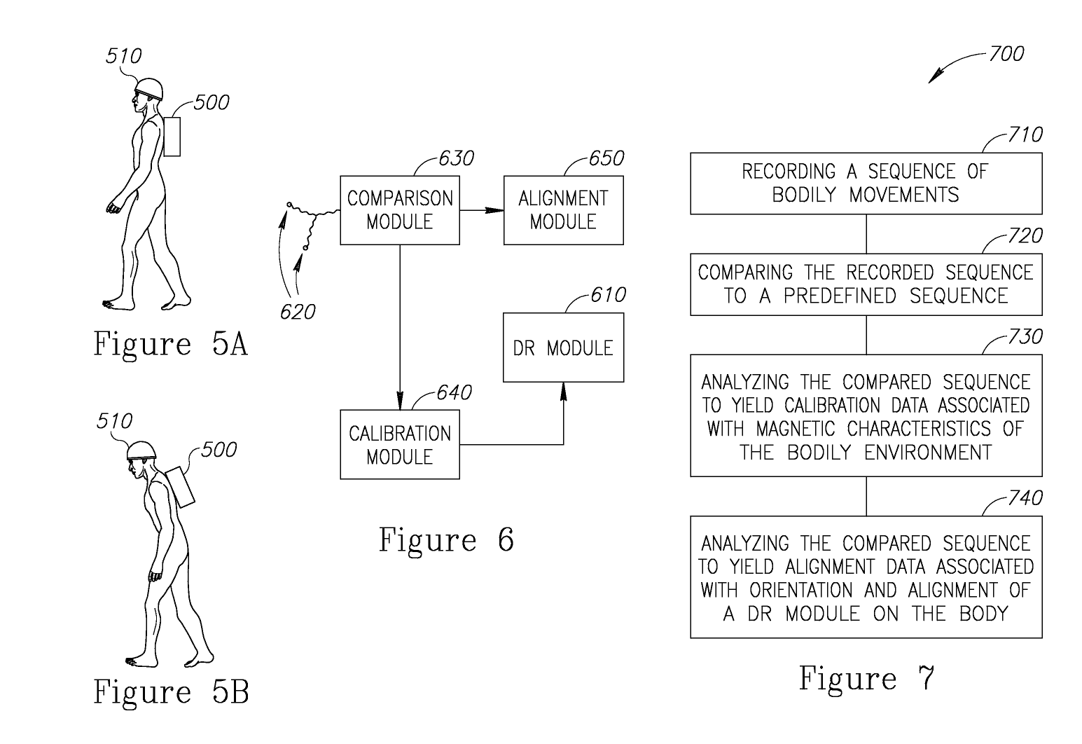

FIGS. 5A and 5B are schematic diagrams illustrating an aspect according to some embodiments of the invention. Navigation system 500 is shown attached to the body of a user 510 in a wearable configuration. In FIG. 5A user 510 stands in a normal position while in FIG. 5B user 510 leans forwards or bends his or her torso forward. This is a non-limiting example of a specified sequence of movements that user 510 is required to perform consonant with a calibration process of a dead reckoning system, in accordance with some embodiments of the invention, as detailed below.

FIG. 6 is a high level schematic block diagram illustrating an aspect of a system according to some embodiments of the invention. System 100 may further include a calibration module 630. In operation, calibration module 630 is configured to record a sequence of bodily movements from sensors 620 (that may be located inside DR module 610) and analyze the recorded sequence to yield calibration data associated with magnetic characteristics of the bodily environment, useable for the DR system.

Consistent with another embodiment of the invention, an ongoing magnetic calibration process may be carried out after the aforementioned initial calibration (i.e., during the actual advancement of the pedestrian over time). The ongoing updated calibration may be achieved, for example, by configuring calibration module 630 to yield an updated calibration data associated with the magnetic characteristics of the immediate bodily environment of the pedestrian, based on momentary readings selected from either magnetic field strength, magnetic field directions or a combination of both. Advantageously, the updated magnetic calibration feature may reflect changes made to the amount of metal (iron) in the immediate environment of the pedestrian, which may lead to a substantial impact on the magnetic environment and the relevant DR readings, thus affecting the overall precision of the DR system.

Consistent with one embodiment of the invention, system 100 may further include an alignment module 650. In operation, alignment module 650 is configured to analyze the compared sequence, to yield alignment/orientation data associated with orientation or alignment of the DR system on the body, useable for determining direction of advancement of the pedestrian.

FIG. 7 is a high level flowchart diagram illustrating an aspect relating to a method according to some embodiments of the invention. Method 700 may include the following steps: recording a sequence of bodily movements 710; comparing the recorded sequence to a predefined sequence 720; (optionally) analyzing the compared sequence to yield calibration data associated with magnetic characteristics of the bodily environment, useable for the DR system; and (optionally) analyzing the compared sequence to yield alignment/orientation data associated with orientation or alignment of the DR system on the body, useable for determining direction of advancement of the pedestrian 740.

Advantageously, as the immediate magnetic environment of a pedestrian (e.g. a soldier) may greatly vary, using the aforementioned calibration feature being simple to follow is of great importance. Similarly, as the navigation system is body mounted, the aforementioned feature of determining the alignment of the actual system on the body has a special importance in pedestrian-carried devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium of any kind or form.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A method of pedestrian navigation based on an external positioning system and a Dead Reckoning (DR) system, the method comprising:
obtaining external position readings from a remote external source, and DR position readings from a pedestrian-carried platform;
estimating an external positioning source error, based at least partially on the external position readings and the DR position readings; and
applying an estimation function to the external position readings, the DR position readings, and the external positioning source error, to yield a corrected estimated position.

2. The method according to claim 1, wherein the external positioning system comprises at least one of: Global Positioning System (GPS), manual position fix, and position fix associated with a source independent of the pedestrian-carried platform.

3. The method according to claim 1, further comprising: deriving pedestrian-eligible positions from a terrain/floor plan database and estimating external positioning source error or DR error based on the pedestrian-eligible positions, wherein the estimation function is further applied to the estimated external positioning source error or the estimated DR error to yield an improved corrected estimated position.

4. The method according to claim 1, further comprising: deriving pedestrian-eligible positions from a terrain/floor plan database, wherein the estimation function is further applied to the pedestrian-eligible positions to yield an improved corrected estimated position.

5. The method according to claim 1, further comprising: recording a sequence of bodily movements; and analyzing the recorded sequence to yield calibration data associated with magnetic characteristics of the bodily environment, useable for the DR system.

6. The method according to claim 1, further comprising: recording a sequence of bodily movements; and analyzing the recorded sequence to yield alignment or orientation data associated with orientation or alignment respectively of the DR system on the body, useable for determining direction of advancement of the pedestrian.

7. A method for calibrating a pedestrian-carried Dead Reckoning (DR) system comprising:
recording a sequence of bodily movements; and analyzing the sequence to yield at least one of: calibration data associated with magnetic characteristics of the bodily environment and alignment or orientation data associated with alignment or orientation respectively of the DR system on the body, wherein the calibration data is useable for calibration of the DR system and wherein the alignment or orientation data is useable for determining direction of advancement of the pedestrian.

8. A system for pedestrian navigation comprising:
an external positioning system;
a Dead Reckoning (DR) system;
an external positioning error estimation module; and
a corrected position estimation module,
wherein the external positioning error estimation module is configured to:
obtain external positioning and DR position readings from the external positioning and the DR systems located on a pedestrian-carried platform, wherein the external positioning reading is provided remotely; and
estimate an external positioning error, based at least partially on the external positioning and the DR position readings, and
wherein the corrected position estimation module applies an estimation function to the external positioning readings, the DR position readings, and the external positioning error, to yield a corrected estimated position.

9. The system according to claim 8, further comprising a terrain/floor plan database and a DR error estimation module, wherein the external positioning error estimation module and the DR error estimation module are configured to derive pedestrian-eligible positions from the terrain/floor plan database and estimate external positioning errors or DR errors respectively, based on the pedestrian-eligible positions, wherein the estimation function is further applied by the corrected position estimated module to the estimated external positioning errors or the estimated DR errors respectively, to yield an improved corrected estimated position.

10. The system according to claim 8 or 9, wherein the external positioning system comprises at least one of: Global Positioning System (GPS), manual position fix, and position fix associated with a source independent of the pedestrian-carried platform.

11. The system according to claim 8, further comprising a terrain/floor plan database containing pedestrian-eligible positions, wherein the estimation function is further applied to the pedestrian-eligible positions, by the corrected position estimated module, to yield an improved corrected estimated position.

12. The system according to claim 8, further comprising a calibration module, wherein the calibration module is configured to recorde a sequence of bodily movements and analyze the recorded sequence of bodily movements, to yield calibration data associated with magnetic characteristics of the bodily environment, useable for the DR system.

13. The system according to claim 8, further comprising an alignment module, wherein the alignment module is configured to record a sequence of bodily movements and analyze the compared sequence, to yield alignment or orientation data associated with alignment or orientation of the DR system respectively on the body, useable for determining direction of advancement of the pedestrian.

14. A pedestrian navigation system comprising:
A Dead reckoning (DR) system;
a terrain/floor plan database;
a DR error estimation module; and
a corrected position estimation module,
wherein the DR system is configured to generate DR position readings,
wherein the DR error estimation module is configured to derive pedestrian-eligible positions from the terrain/floor plan database and estimate external DR errors based on the pedestrian-eligible positions and the DR position readings,
wherein the corrected position estimation module is configured to apply an estimation function to the DR position readings and the estimated DR errors respectively, to yield an improved corrected estimated position.

15. A system for calibrating a pedestrian-carried Dead Reckoning (DR) system comprising:
a DR module configured to generate DR position readings;
sensors configured to record a sequence of bodily movements;
analyzing module configured to analyze the recorded sequence to yield at least one of: calibration data associated with magnetic characteristics of the bodily environment and alignment or orientation data associated with alignment or orientation respectively of the DR system on the body, wherein the calibration data is useable for calibration of the DR system and wherein the alignment or orientation data is useable for determining direction of advancement of the pedestrian.

16. The system according to claim 15, wherein the analyzing module is further configured to yield an updated calibration data associated with the magnetic characteristics of the bodily environment based on repeated momentary readings of at least one of: magnetic field strength and magnetic field directions.
